(19) United States
(12) Patent Application Publication
(10) Pub. No.: US 2020/0072096 A1
(43) Pub. Date: Mar. 5, 2020

(54) COMBUSTION CHAMBER OF ENGINE

(71) Applicants: HYUNDAI MOTOR COMPANY, Seoul (KR); KIA MOTORS CORPORATION, Seoul (KR)

(72) Inventors: Tae-Won LEE, Incheon (KR); Hong-Kil BAEK, Seoul (KR); Seung-Woo LEE, Seoul (KR)

(73) Assignees: HYUNDAI MOTOR COMPANY, Seoul (KR); KIA MOTORS CORPORATION, Seoul (KR)

(21) Appl. No.: 16/210,123

(22) Filed: Dec. 5, 2018

(30) Foreign Application Priority Data
Aug. 28, 2018 (KR) 10-2018-0101513

(51) Int. Cl. F01L 3/20; F02F 1/42

(52) U.S. Cl. CPC F01L 3/20; F02F 1/4235

(57) ABSTRACT

A combustion of an engine include: an intake valve; a diameter formed by a point of contact between the intake valve and a valve seat; a diameter of an intake valve head; and a diameter of an imaginary extension line extended from the inner lower end portion of a cylinder head. In particular, a diameter formed by the point of contact between the intake valve and the valve seat and the diameter of the intake valve head may have a diameter difference less than or equal to a constant value, and the diameter of the intake valve head and the diameter of the imaginary extension line extended from the inner lower end portion of the cylinder head may be maintained by a diameter difference greater than or equal to a constant value after the valve seat is worn.

### CROSS-REFERENCE TO RELATED APPLICATION

This application claims priority to and the benefit of Korean Patent Application No. 10-2018-0101513, filed on Aug. 28, 2018, the entire contents of which are incorporated herein by reference in its entirety.

### FIELD

The present disclosure relates to a combustion chamber of an engine.

### BACKGROUND

The statements in this section merely provide background information related to the present disclosure and may not constitute prior art.

Generally, in an engine, as shown in FIG. 1, a cylinder head is connected to the upper portion of a cylinder and a piston is installed in the cylinder to form a combustion chamber.

In the cylinder head 2, an intake valve 8 for intake of the mixture or air into the combustion chamber and an exhaust valve 12 for discharging exhaust gas after combustion are installed in an intake port 10 and an exhaust port 14, respectively, and a valve seat 16 is formed at a portion of the cylinder head 2 which is in contact with the intake valve 8 and the exhaust valve 12 so that the airtightness of the intake valve 8 and the exhaust valve 12 is enhanced. The valve seat 16 is integrally formed with the cylinder head 2 or separately formed to be assembled to the cylinder head 2.

On the other hand, as the operating time of the engine increases, the valve seat 16 is worn to increase the contact width of the intake valve 8 and the valve seat 16, which deteriorates the flow rate flowed into the combustion chamber, so that the output performance of the engine system becomes worse.

As shown in FIG. 2, initially, the intake valve 8 and the valve seat 16 are contacted by the width of W1, but as the engine operating time increases, the valve seat 16 wears and the contact width of the intake valve 8 and the valve seat 16 is increased to be the width (e.g., W2) greater than the initial contact width.

We have discovered that, as the contact width between the intake valve 8 and the valve seat 16 increases, the gap (G) between the intake valve 8 and the cylinder head 2 decreases, resulting in deterioration of volumetric efficiency and cooling loss, thereby deteriorating the output performance of the engine.

Conventionally, the diameter of the intake valve 8 was selected considering the contact width of the intake valve 8 and the valve seat 16 after wear of the valve seat 16 without considering volumetric efficiency or cooling loss in selecting the diameter of the intake valve 8, so that the diameter size of the intake valve 8 is set to be relatively large.

Due to this, as the operation time of the engine increases, the gap (G) between the intake valve 8 and the cylinder head 2 decreases to increase the flow resistance. The volumetric efficiency of the engine is deteriorated due to the increase of the flow resistance, which became a factor deteriorating the engine performance.

The foregoing is intended merely to aid in the understanding of the background of the present disclosure, and is not intended to mean that the present disclosure falls within the purview of the related art that is already known to those skilled in the art.

### SUMMARY

The present disclosure has been made to solve the above problems and the object thereof is to provide a combustion chamber of an engine capable of preventing the deterioration of volumetric efficiency by reducing or inhibiting the resistance of the flow flowed into through an intake valve from increasing even if the contact width between the intake valve and a valve seat increases as the operation time of the engine increases.

A combustion chamber of an engine in one form of the present disclosure may include: an intake valve; a valve seat contacting with the intake valve, forming a contract line together, where the contact line has a first diameter; an intake valve head having a second diameter; and a cylinder head including an inner lower end portion having a third diameter defined by an imaginary extension line extended from the inner lower end. In particular, a diameter difference between the first diameter and the second diameter is less than or equal to a constant value, and a diameter difference between the second diameter of the intake valve head and the third diameter of the inner lower end portion of the cylinder head are maintained to be greater than or equal to a constant value after the valve seat is worn by the diameter difference between the first diameter and the second diameter.

The diameter difference between the first diameter and the second diameter may be approximately 0.4 mm or less.

An initial contact width of the intake valve and the valve seat may be approximately 1.5 mm or more.

An angle between a center axis of the intake valve and a face portion of the valve seat, which is not contacted with the intake valve in an initial state, may be approximately 65 degrees or more.

The diameter difference between the second diameter of the intake valve head and the third diameter of the inner lower end portion of the cylinder head may be approximately 4.0 mm or less.

In accordance with the present disclosure, as the operation time of the engine increases, the gap (G) between the intake valve and the cylinder head can be inhibited or prevented from being narrowed even if the contact width between the intake valve and the valve seat increases.

Therefore, even if the operation time of the engine increases, it is possible to reduce or prevent deterioration of the volumetric efficiency by preventing the resistance of the flow flowed into through the intake valve from increasing.

In this way, despite the increase in the operating time of the engine, the volumetric efficiency is maintained at the initial state of the engine, thereby reducing or preventing the performance of the engine from being deteriorated.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross sectional view showing a combustion chamber structure of a conventional engine;

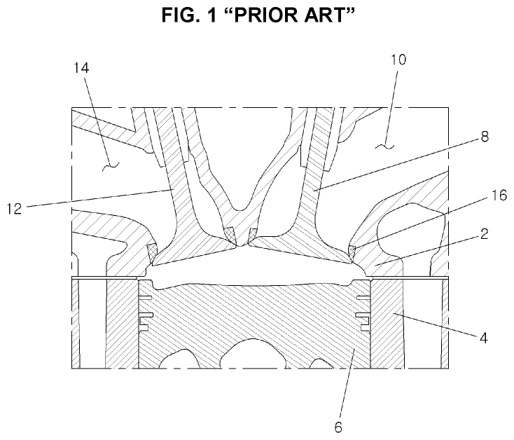

FIG. 2 is a magnified cross-sectional view showing the contact area between an intake valve and a valve seat shown in FIG. 1;

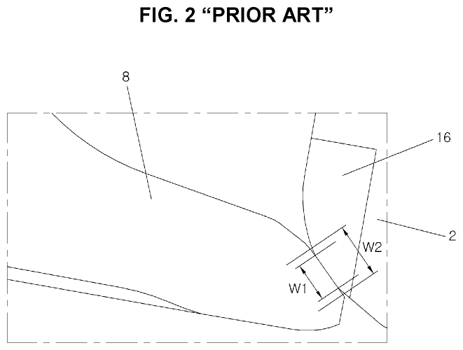

FIG. 3 is a cross-sectional view showing a state where the gap between the intake valve and a cylinder head is narrowed due to wear of the valve seat;

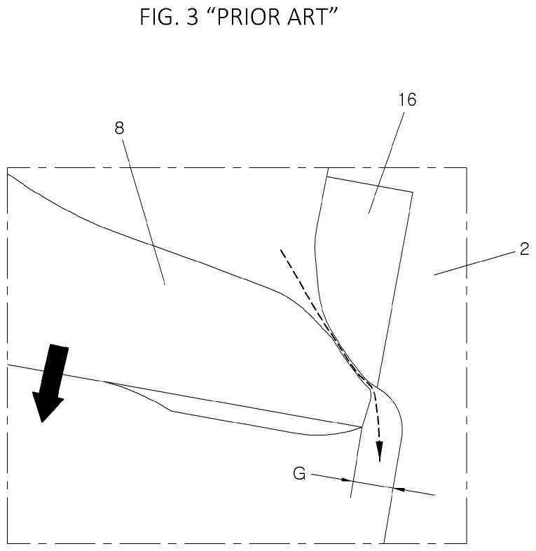

FIG. 4 is a cross-sectional view showing an installation state of the intake valve according to the present disclosure;

FIGS. 5A and 5B are detailed views of the diameter Do formed by the contact point between the intake valve and the valve seat in FIG. 4;

FIG. 6A is a cross-sectional view showing a state where the diameter of the intake valve of the present disclosure is sufficiently larger than the contact area of the valve seat;

FIGS. 6B and 6C are cross-sectional views showing a state where a stepped portion is formed on the valve seat due to wear when the diameter of the intake valve is not sufficiently large;

FIG. 7 is a cross-sectional view to explain the reason for selecting an angle between a center axis of the intake valve and the non-contact face portion of the valve seat according to the present disclosure; and

FIG. 8 is a cross-sectional view to explain the reasons for selecting the contact width between the intake valve and the valve seat according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Exemplary forms of the present disclosure may be modified in various forms and the range of the present disclosure should not be construed as limited to the exemplary forms detailed below. The present exemplary forms are provided to more fully describe the present disclosure to those skilled in the art. Thus, the shape, and the like of an element in a drawing can be exaggerated to emphasize a clearer description. Detailed descriptions of known features and configurations that may unnecessarily obscure the gist of the present disclosure are omitted.

The present disclosure relates to a combustion chamber of an engine, more particularly, the present disclosure relates to a combustion chamber of an engine capable of preventing the deterioration of volumetric efficiency by preventing the resistance of the flow flowed into through an intake valve from increasing even if the contact width between the intake valve and a valve seat increases as the operation time of the engine increases.

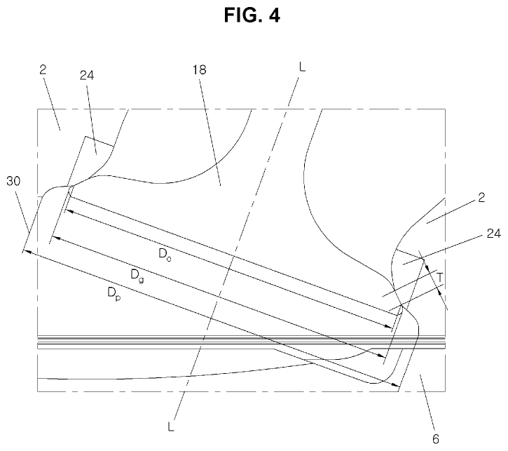

FIG. 4 is a cross-sectional view showing an installation state of the intake valve according to the present disclosure.

In one form, an intake valve 18 may include an intake valve face portion 20 to extend downwardly in order to have a slanted surface of a constant angle in the circumferential direction of a head portion, and a rim portion 22 extending downwardly by a predetermined length from the intake valve face portion 20 so as to be parallel with a central axis L of the intake valve 18.

A valve seat 24 formed at a portion of a cylinder head 2 with which the intake valve 18 is contacted, may include a valve seat face portion 26 which is in contact with the intake valve face portion 20 to be worn and extends downwardly so as to have an slanted surface at a constant angle, and a non-contact face portion 28 bent at a constant angle from the valve seat face portion 26 to be extended.

The intake valve face portion 20 may be formed to have a greater width than the valve seat face portion 26.

The angle between the center axis L of the intake valve and the intake valve face portion 20 is approximately 45.5 degrees, and the angle between the center axis L of the intake valve and the valve seat face portion 26 is smaller than the angle between the center axis L of the intake valve and the intake valve face portion 20.

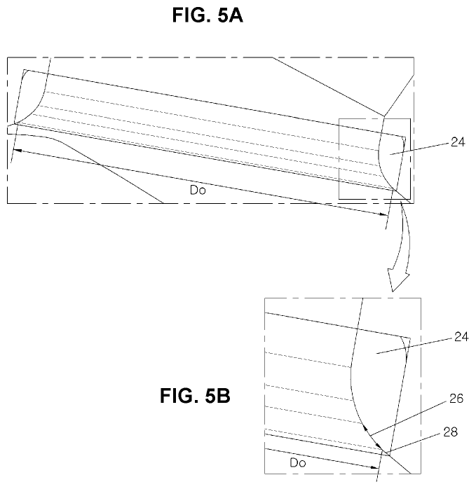

That is, in the initial state, as shown in the drawing, the intake valve face portion 20 and the valve seat face portion 26 are not in line contact with each other, and referring to FIGS. 5A and 5B, the intake valve face portion 20 and the valve seat 24 are in contact only at the lowermost point of the valve seat face portion 26 such that the contact between the intake valve face portion 20 and the valve seat face portion 26 forms a line contact together, having a diameter.

The diameter Dg of the rim portion 22 may be selected considering the diameter difference between the diameter Dp of an imaginary extension line 30 extended from the inner lower end portion of the cylinder head 2 and the diameter Dg of the rim portion in order to solve the problem of lowering the volumetric efficiency, which is generated by the decrease of the gap G between the rim portion 22 and the cylinder head 2 as the contact width of the intake valve face portion 20 and the valve seat face portion 26 increases due to wear of the valve seat face portion 26.

In order that the diameter difference between the diameter Dp of an imaginary extension line 30 extended from the inner lower end portion of the cylinder head 2 and the diameter Dg of the rim portion is maintained above a constant diameter difference, even after the valve seat face portion 26 is worn, the diameter Dg of the rim portion may be formed to have the diameter difference equal to or less than a constant value with respect to a diameter Do formed by a point at which the valve seat 24 contacts the intake valve face portion 20 in an initial state, which is reduced compared to the prior art.

In one form, the diameter difference between the diameter Dg of the rim portion and the diameter Do formed by the point where the intake valve face portion 20 contacts the valve seat 24 is approximately 0.4 mm or less.

Even after the valve seat face portion 26 is worn by the diameter difference between the diameter Do formed by a point at which the valve seat 24 contacts the intake valve face portion 20 and the diameter Dg of the rim portion, the diameter difference between the diameter Dg of the rim portion and the diameter Dp of an imaginary extension line 30 extended from the inner lower end portion of the cylinder head 2 is maintained at a constant value or more.

It is preferable that the diameter difference between the diameter Dg of the rim portion and the diameter Dp of an imaginary extension line 30 extended from the inner lower end portion of the cylinder head 2 is approximately 4.0 mm or less.

The imaginary extension line 30 extended from the inner lower end portion of the cylinder head may be parallel with the center axis L of the intake valve.

In a case of reducing the diameter Dg of the rim portion considering only the maintenance of the diameter difference between the diameter Dg of the rim portion and the diameter Do formed by a point at which the valve seat 24 contacts the intake valve face portion 20, the flow resistance can be reduced to increase the volumetric efficiency, but a step portion may be generated when the valve seat face portion 26 is worn because the diameter Dg of the rim portion is reduced.

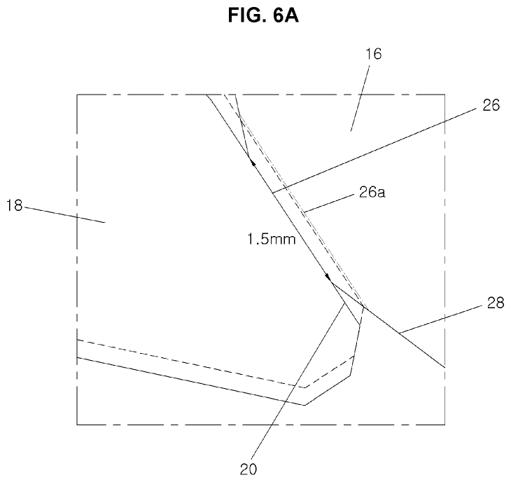

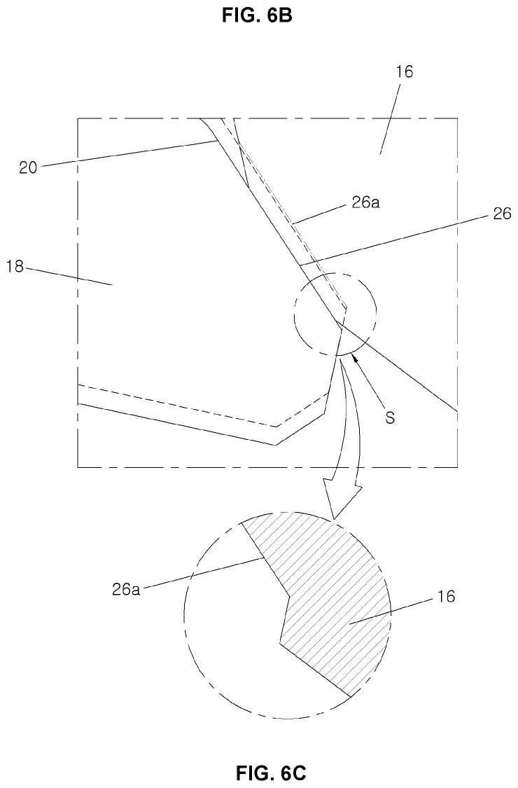

Referring to FIGS. 6A-6C, this will be explained.

FIG. 6A to FIG. 6C are drawings to explain why the diameter of the intake valve of the present disclosure is formed large enough; FIG. 6A is a cross-sectional view showing a state where the diameter of the intake valve of the present disclosure is sufficiently larger than the contact area of the valve seat; and FIGS. 6B and 6C are cross-sectional views showing a state where a stepped portion is formed on the valve seat due to wear when the diameter of the intake valve is not sufficiently large.

When the intake valve 18 reciprocates and the valve seat face portion 26 and the intake valve face portion 20 are contacted, the valve seat face portion 26 is worn.

When the diameter Dg of the rim portion is sufficiently larger than a certain diameter, as shown in FIG. 6A, even if the valve seat face portion 26 is worn, the entire width of the worn valve seat face portion 26 may be contacted to the intake valve face portion 20. If the diameter Dg of the rim portion is not large enough below a certain diameter, as shown in FIGS. 6B and 6C, when the valve seat face portion 26 is worn, the entire width of the valve seat face portion 26 is not contacted with the intake valve face portion 20, causing a step portion in the valve seat face portion 26, which generates a problem that leakage occurs in a state where the valve 18 is closed.

In other words, if the diameter Dg of the rim portion is reduced considering only the gap G between the imaginary extension line 30 extended from the inner lower end portion of the cylinder head 2 and the rim portion, a step may occur in the valve seat face portion 26. Thus, in the present disclosure, the angle A between the center axis L of the intake valve and the face portion 28 of the valve seat, which is not contacted with the intake valve 18 in the initial state, is defined so that the gap G between the imaginary extension line 30 extended from the inner lower end portion of the cylinder head 2 and the rim portion is maintained at a constant gap or more, thereby inhibiting or preventing the step portion from being generated in the valve seat face portion 26.

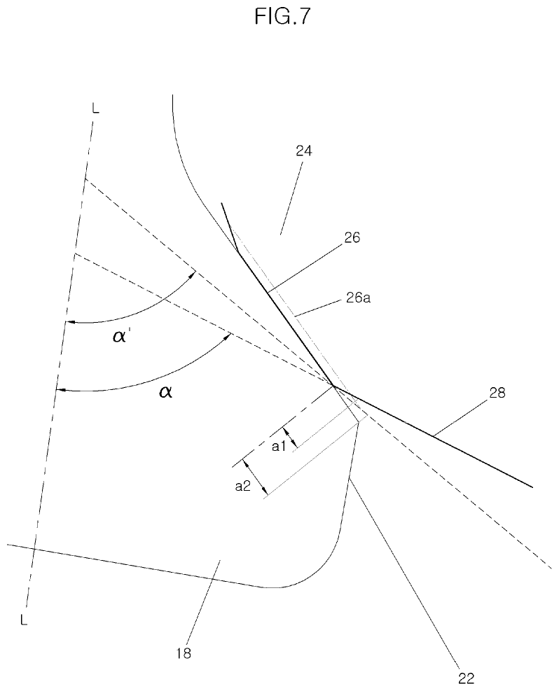

FIG. 7 is a cross-sectional view to explain the reason for selecting the angle A between the center axis of the intake valve and the non-contact face portion of the valve seat according to the present disclosure.

When the angle A is approximately 60 degrees (α′), if the wear of about 200 μm on the valve seat face portion 26a occurs, the width of the valve seat face portion 26a is increased by about 0.938 mm from the initial state.

Considering the increased width of the valve seat face portion 26a, the tolerance of the rim portion diameter Dg, and the tolerance of the diameter Do formed by the point where the intake valve face portion 20 is contacted with the valve seat 24, when the angle A is approximately 60 degrees (α′) and about 200 μm wear occurs on the valve seat face portion 26a, the width a2 of the intake valve face portion 20 desired to be further contacted with the valve seat face portion 26a is about 1.017 mm in total.

When the angle A is approximately 75 degrees (α), if the wear of the valve seat face portion 26 is about 200 μm, the width of the valve seat face portion 26a is increased by about 0.542 mm from the initial state.

Considering the increased width of the valve seat face portion 26a, the tolerance of the rim portion diameter Dg, and the tolerance of the diameter Do formed by the point where the intake valve face portion 20 is contacted with the valve seat 24, when the angle A is approximately 75 degrees (α) and about 200 μm wear occurs on the valve seat face portion 26a, the width a1 of the intake valve face portion 20 desired to be further contacted with the valve seat face portion 26a is about 0.620 mm in total.

That is, when the angle A is increased and the valve seat face portion 26 is worn, the width of the intake valve face portion 20 desired to be further contacted with the valve seat face portion 26a may be reduced.

Therefore, due to the limitation of the angle A, the width of the intake valve face portion 20 is reduced so that the diameter Dg of the rim portion 22 can be reduced, and the entire width of the valve seat face portion 26a is contacted with the intake valve face portion 20, thereby solving the problem of generating a step on the valve seat face portion 26 by the reduction of the diameter Dg of the rim portion 22.

In one form, the angle A between the center axis L of the intake valve and the face portion 28 of the valve seat, which is not contacted with the intake valve 18 in the initial state, is approximately 65 degrees or more.

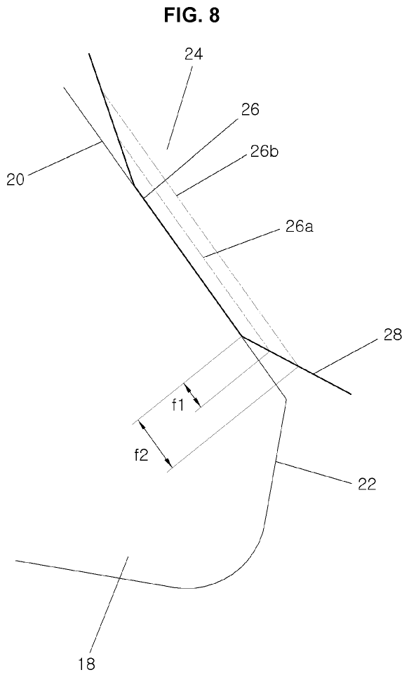

FIG. 8 is a cross-sectional view to explain the reasons for selecting the contact width between the intake valve and the valve seat according to the present disclosure.

As the wear of the valve seat face portion 26 progresses, the contact width of the valve seat face portion 26 and the intake valve face portion 20 increases.

Since the load of the intake valve 18 applied per unit area is reduced as the contact width of the valve seat face portion 26 and the intake valve face portion 20 increases (f1→f2), increasing the contact width of the valve seat face portion 26 and the intake valve face portion 20 can reduce the wear of the valve seat face portion 26.

Therefore, in the present disclosure, the initial contact width (i.e., the initial width of the valve seat face portion 26) of the valve seat face portion 26 and the intake valve face portion 20 is set to 1.5 mm or more so that the load of the intake valve 18 applied per unit area can be reduced.

The exemplary forms of the combustion chamber of the engine of the present disclosure engine described above are merely illustrative and it will be apparent to those skilled in the art that various modifications and equivalent forms may be made without departing from the scope of the present disclosure. Therefore, it should be understood that the present disclosure is not limited to the form described in the detailed description above. Therefore, the true technical protection range of the present disclosure should be determined by the technical idea of the appended claims scope. It is also to be understood that the present disclosure encompasses the spirit of the present disclosure, as defined by the appended claims, and all variations, equivalents, and alternatives falling within that scope.

1. A combustion chamber of an engine, comprising:
an intake valve including an intake valve face portion, and a rim portion extending downward from the intake valve face portion;
a valve seat having a valve seat face portion configured to contact the intake valve face portion of the intake valve, forming a line contact together along lowermost points of the valve seat face portion, where the line contact has a first diameter and the rim portion has a second diameter; and
a cylinder head including an inner lower end portion having a third diameter defined by an imaginary extension line extended from the inner lower end in parallel with a central axis of the intake valve,
wherein a diameter difference between the first diameter and the second diameter is less than or equal to a first predetermined value; and
wherein a diameter difference between the second diameter of the rim portion and the third diameter of the inner lower end portion of the cylinder head are maintained to be greater than or equal to a second predetermined value after the valve seat is worn by the diameter difference between the first diameter and the second diameter,
wherein the intake valve face portion and the valve seat face portion are in contact only at the lowermost points of the valve seat face portion, and
wherein the second diameter of the rim portion is determined such that the second predetermined value is greater than the first predetermined value.

2. The combustion chamber of the engine of claim 1, wherein the diameter difference between the first diameter and the second diameter is approximately 0.4 mm or less.

3. The combustion chamber of the engine of claim 1, wherein an initial contact width of the intake valve and the valve seat is approximately 1.5 mm or more.

4. The combustion chamber of the engine of claim 1, wherein an angle between a center axis of the intake valve and a face portion of the valve seat, which is not contacted with the intake valve in an initial state, is approximately 65 degrees or more.

5. The combustion chamber of the engine of claim 1, wherein the diameter difference between the second diameter of the intake valve head and the third diameter of the inner lower end portion of the cylinder head is approximately 4.0 mm or less.
